(19) United States
(12) Patent Application Publication
(10) Pub. No.: US 2003/0124502 A1
(43) Pub. Date: Jul. 3, 2003

(54) Computer method and apparatus to digitize and simulate the classroom lecturing

(76) Inventor: Chi-Chin Chou, Taipei (TW)

Correspondence Address: BACON & THOMAS, PLLC, 625 SLATERS LANE, FOURTH FLOOR, ALEXANDRIA, VA, 22314

(21) Appl. No.: 10/325,869

(22) Filed: Dec. 23, 2002

(30) Foreign Application Priority Data
Dec. 31, 2001 (TW) 90133072

(51) Int. Cl. G09B 3/00

(52) U.S. Cl. 434/350

(57) ABSTRACT

A computer method and apparatus to “digitize” and simulate the classroom lecturing is disclosed. A teacher can use the apparatus to draw on a web page or on a computer whiteboard with extensible size, dynamically insert (delete) image and text objects into (from) the whiteboard or the web page, and record voice narration at the same time. The apparatus stores these activities into a multiplexed data stream and a header stream. The combination of streams and the annotated web page is called an audio-graph (AG) item. Users could save the streams to a file, e-mail it, or upload it to a web site for streamed playback. The apparatus is a system of authoring, playback, organize, and indexing the AG items. The data stream of an AG item comprises (compressed) audio frames, (compressed) stroke frames, image and text frames. The header stream comprises information messages, and event messages (with timing) that are used to control the display (window) during playback. By using event messages and stroke temp files (a text file of strokes), the present invention is able to reduce the delay caused by the pre-processing (1) before user can begin to input voice and stroke during record, or before user can begin to see result during playback. The present invention uses multiple event arrays internally to reduce the frequency and complexity of data stream (file) manipulation during editing (e.g., insert new data stream by record). The system segments the usually very long data stream to many smaller segmented data streams before the AG item is uploaded to the web site. The segmentation information (such as the number of the segments) and the locations are stored in the header stream. The separation of streams to header and segmented data streams enable online playback with little waiting time, even for a very slow and congested network. A group of AG items could be constructed to an AG course. An AG course could be a linked or embedded. A linked AG course is that some of its AG items are stored outside of the AG course file; otherwise it is an embedded AG course. User can save a course to a file, e-mail it or publish to the web site just like a single AG item.

### FIELD OF THE INVENTION

The present invention relates to record, playback, organize, and publish the multiplexed stream of the audio narration, drawing annotation, dynamical creation of image and text objects to a computer whiteboard or web page.

### BACKGROUND OF THE INVENTION

Today the Internet has changed the human life in all the fronts. The Internet is just like a super highway that connects everyone on the planet. It becomes so easy and quick for people to get information anytime and anywhere. Many begin to use Internet in business, research, education, and many other areas. The so-called e-business is flourishing all over the world. The e-learning, which is the main application of the present invention, is also getting popular.

In the traditional distance-learning system the school mails the educational material such as textbook and manuals to the students scattering over different locations. The textbook and manuals are usually not as effective as classroom lecturing because it is more static, and it is lack of the audience member-teacher-classroom interaction. Although the classroom lecturing might be effective, sometimes it is difficult, costly, and inconvenient to arrange for students from disparate locations to meet together.

To solve the problem associated with bringing people together, complex technologies have been developed to facilitate distributed learning. However many distributed learning systems such as close cable system (CCS) are expensive to set up. Thanks to the popularity of the Internet, many traditional distance-learning institutes such as Phoenix University have begun to provide online learning program in 90's. The online learning which offers the benefits of schedule-free, location-free, repeating learning experience has become the hottest area of computer-based educational system in the art.

With the help of tools such as Microsoft FrontPage, Macromedia Flash, or Click2Learn Assistant, user could create many different types of presentation of online learning. An author might choose one type than the others by the following reasons.

1. Effectiveness—how effective of one kind of presentation may be dependent on the type of educational material itself. Some is good enough to be presented as a sequence of web pages and some may be better in a form similar to videotape.

2. Cost—this includes the cost of authoring, maintenance, and distribution of the course.

3. Tool—some tools might require special skilled people to use.

4. Availability—How the users get the course? Is it a platform independent? Which version of Microsoft explorer is required? Etc.

5. Bandwidth—if it is to be accessed from home, author has to consider the low bandwidth limitation. Most of streamed video-on-demand requires high bandwidth to have acceptable quality.

6. Others.

Despite of seemly different forms of presentation of online learning, we might roughly categorize them to three types. The first and most commonly used type of online learning is a sequence of web pages that are related by hyperlink. We call this as web-page-based presentation of online learning. An author might use tools such as Microsoft FrontPage to create the web page or use tools such as Microsoft PowerPoint to create slide shows (which can be viewed as a special web page). A web page might contain different kinds of objects, such as text, image, audio clip etc.

The second type of presentation of online learning is the form of streaming multimedia.

We call this as stream-based presentation of online learning. The stream might be a video-on-demand created by the tools such as Microsoft NetShow, or RealNetworks RealPlayer, an animation-on-demand created by the tools such as Macromedia Flash, or the other variants of streaming multimedia.

The third type of presentation of online learning is the hybrid of previous two types. We call this as web-page-stream-based. For example, an author might use tools such as beta version of Microsoft Producer to create a streamed video-on-demand accompanying with a slide show FIG. 1, a user can plug into the appropriate film in the video section 11 to explain in detail the slide contents 13, and menu 12 then available select to change to other slide.

Consider the commonly used web-page-based type of presentation. A web page is a file that can be displayed by the browser. Regardless of its effectiveness, the advantages of this kind of presentation are:

1. Easy to create and modify the presentation—An author can use tools such as FrontPage and PowerPoint to create simple web pages. It is very easy to change the content of web pages as long as they are simple. However a web page might contains multimedia objects that require special authoring tools and hence increases the difficulty of authoring. For example the author could use Macromedia Flash to create animation clips. In this case the author needs to learn how to use the tool and might spend a lot of time to produce fine animation clips.

2. Low maintenance cost—When the web pages are simple the author might just need a web (HTTP) server and suitable storage. There is no need for special services to be installed on the web server.

3. Platform independent—the operating system of the server could be a Window NT, Solaris, Linux or anything that provide HTTP and FTP services. The user might use any browser such as Microsoft Explorer or Netscape as a HTTP client on any PC.

4. Low bandwidth requirement—the file size of most of simple web page that comprises text and image objects is not large. Hence the delay of downloading the file is acceptable. On contrary, if the web page has video or animation clips, the delay might be significant.

What are the disadvantages of using web-page-based presentation? Compare with the common classroom environment. In this case the author delivers his knowledge through lecturing. The lecturing mainly comprises the audio narration and graph on the chalkboard from the teacher. The student receives the information in the form of continuous audio and graph without interruption (e.g., you don't have to “activate” to get speech comment), and the student is able to interact with the teacher. Now consider the web-page-based presentation. The web-page-based presentation is just like reading a rich and hyperlink textbook on the computer. Although the web page could have audio, video or animation clips, it usually requires users to activate. Most of cases it lacks of continuous audio narration and guidance from the author. The web-page-based presentation is static or non-automatic. This means that most of times the web pages won't scroll or jump to the next page automatically. Also for a text-focus web page it may be not enough to give clear explanation about a subject and it may be hard for users to constantly stare at the tiny words on the screen for too long. From the observation the disadvantages of the web-page-based presentation can be summarized as the followings:

1. Passiveness and boredom—since there is no audio guidance and it is similar to an online textbook, ordinary user might just feel passive and bored.

2. Distraction—during learning the user might need to scroll, click menu buttons to get what he want to see or hear. Furthermore user has to endure the interruption caused by the intermittent delay of downloading the web page, audio and video clips for low or congested network.

3. Less effective—comparing to the continuous audio and graph narration of lectures, the information that can be got from the text-focus web-page-based presentation may not be rich enough.

The characteristic of web-page-based presentation that tends to cause the interruption and discontinuity makes it less attractive. It would be nice if have a presentation that is similar to the classroom lecturing that the information is delivered in a streamed and continuous manner.

With the advance of audio, video and other compression technologies many companies and schools start to use stream-based or web-page-stream-based presentation for online learning.

Typically a user invokes a hyperlink (ActiveX or Plug-In) object on a web page to connect user PC to a media server on some web site. The ActiveX or Plug-In usually bring up a new window inside the browser or simply starts a new application to display the streamed content. After it receives the request from the client, the media server starts to “push” the streamed content into the display window. The stream content could be a pure audio, pure video, audio and video, or animation etc. As for the web-page-stream-based presentation, in addition to afore mentioned stream types, the media server might send the text string as commands to the client. For example, a realization of web-page-stream-based presentation uses Microsoft NetShow media server to push audio/video, or illustrated audio (audio and still images) to the client. The content of NetShow is saved as an Active Streaming Format (ASF). The ASF is a low-overhead storage and transmission file format that encapsulates multimedia data (image, audio and video) as well as the embedded text (e.g., URLs). The ASF synchronize the different type of content within a stream. One might use the embedded text as commands or instructions to draw line, circle and other simple graph on the still image (slide).

It is obvious that the audio-only stream might not be enough for the online learning since the visual information is important in this case. The animation stream is usually created by special authoring tools such as Macromedia Flash and requires time and skill. It is often used as a short introduction occasionally. Probably the most suitable stream format for online learning is either streamed audio-video-on-demand (simply called video-on-demand) or its extension that includes illustrated slides additionally.

The video-on-demand is often used for online news broadcasting. It can be viewed as online videotape. Using videotape as a supplemental and home education has been very common for years. Because of its similarity to the videotape the video-on-demand should be easily accepted as a mean of online learning, at least comparing to the web-page-based online presentation. Further, the video-on-demand is easy to make, simply by recording. In fact one can simply digitize the content of videotape to create video-on-demand presentation. However there are many difficulties of using video-on-demand, at least in current environment:

1. Bandwidth—The digitized video usually occupies large quantity of storage. This means to transmit the video-on-demand stream requires high transmission rate or bandwidth over the Internet. Even with the most modern video compression algorithms such as MPEG and H.263, the minimal bandwidth to transmit the acceptable quality of video is still over tenth or hundred of Kbytes per second. Although the clarity of video might not be so important in news broadcasting, it does in online presentation. For users with slow Internet connection it is common to encounter the problems of intermittent pause due to network congestion and buffering, and unpleasant choppy and low-resolution video frames.

2. Resolution—As mentioned above, the video-on-demand is usually made from digitizing the analog videotape. Most of analog videotape has limited resolution such as 320*240 for TV. Thus it is very hard to see the drawing clearly saved in the video-on-demand stream.

3. Cost—To make digitized video-on-demand needs good equipment and large storage space. Also it may require special service such as Microsoft Media Server to be installed on the web server that distributes the video-on-demand stream.

4. Limited functions for interaction—Most commercial video-on-demand client system such as RealPlayer is mainly designed for the applications of news and music broadcasting. Thus the capability of user interaction is limited in most of the systems. For example, there are no functions found in the commercial systems for user to rewind to any position of stream, to print the content, to save the stream for offline viewing, or to instantly send the audio or video response back etc.

In the case of traditional classroom environment the teacher's audio narration and graph annotation on the chalkboard are usually important than the teacher's image. But due to the resolution problem, the drawing of the recorded video is often not clear enough. It only gets worse when it is digitized to make video-on-demand presentation. Thus a new method of recording the drawing and audio is desirable.

As mentioned above, the illustrated audio-on-demand (slides shows) created by the tools, such as Microsoft NetShow ASF, might be the closest one to our expected system. However one can only save simple graph (meta) commands to the ASF stream in this system, it is still not flexible enough for creating arbitrary drawing.

The present invention discloses a new method and apparatus to meet the above expectation. In the present invention the author can record voice and arbitrary drawing on a computer whiteboard. The whiteboard can be easily extended to any size. The system compresses and mixes the record audio and drawing to stream that can be distributed over the Internet. In fact this is just one of many uses of the present invention. In addition to this basic use, the present invention also enables numerous functions. For example, during record the author can dynamically insert images and text into the whiteboard, and delete them later. User can transform the drawing, images and text to a web page. Another extension is that not only the author can draw on a whiteboard; he can also draw directly on any web page. This is handy for user who wants to make drawing annotation and voice narration over a word document, a picture, or html web page. Note that many document formats such as Microsoft Words can be easily saved as a web page. In this case, the whiteboard is considered as a special case of empty-web-page. The stream created by the present invention is called audio-graph stream, AGS. Users creates graph by freeform drawing and inserting image and text objects. The present invention defines the format and syntax of the AGS, provides a record subsystem to create the AGS and playback subsystem to decode and play back the AGS, whether it is located at local or at a remote web site. The present invention not only is a tool to create online stream presentation, it is also a tool to create a CD-ROM courseware and a tool for collaboration.

### SUMMARY OF THE INVENTION

From the above discussion of the status of online learning, the present invention discloses a novel system for users to create audio-graph streamed online course that can be smoothly played back even with a slow online connection. The initial goal of the present invention is to use the Internet and computer to simulate the traditional classroom lecturing. The “simulation” is done by digitizing the teacher's audio and graph annotation on the computer whiteboard to a synchronized and multiplexed stream. When the stream and the web page are published to a web site, the students can use the computer that connects to the Internet to play back the stream. Beside of the goal of simulating the classroom lecturing, the present invention has other applications that will be explained in next sections. The following is the summary of the invention.

First, the present invention allows users to record and play back an audio-graph annotation over a whiteboard or over a web page. Refer to FIGS. 2(a) and 2(b), the control panel 22 provides the every kind of tool for choice (e.g., the dimension of color of the pen) or function to change the page. Selection row 21 provides the select of operation mode, for example idle, pause, playback, and record etc. White board 23 can be provided to draw, for example write a word or describe a circle. Web page+transparent window 232 can import a web page, and the transparent window can then provide users to directly add an annotation or some legend texts in the opposite site of the web page. If the user has any questions at the graphs (or figures) and texts on a web page, an AG item can be made by pointing the input-pen at the place having question and recording the relative inquiry speech. In addition, status row 24 can display current status of system, for example whether microphone mount or not etc.

A web page is defined as any file that can be displayed by a web browser. It can be a text file, an image file such as jpeg (.jpg), or an html document. Since a whiteboard can be implemented as an empty web page with arbitrary size, it is considered as a special web page in the following discussion.

The system generally operates in one of idle, record and playback mode. During record the author chooses a web page to add audio-graph annotation. We call the annotated web page the audio-graph (AG) item. The invention lets the author record his/her voice and perform freeform drawing on the web page at the same time. Unlike many documentation software applications such as Microsoft Words, which can be considered as text-focus (keyboard) application, the present invention has more emphasis on the freeform drawing (pen-device) and audio. However the user still can use the present invention to enter text and image during record mode by inserting text and image objects to the web page.

The system uses a transparent window atop the web page. The user actually draws on the transparent window instead of the web page FIG. 2(b). Because of its transparency the drawing appears directly on the web page. Although it is technically possible to insert graphs to the web page during record, there are performance, latency and quality issues with this direct approach (we will discuss this in next section). Beside that the user can create the graph by drawing, he can also create the graph by inserting images and text blocks to the transparent window. After the user exits from the record mode (i.e. the transparent window is removed and the system enter idle mode), he can request the system to actually insert drawing, image and text to the web page by using the techniques of script language (Java Script), dynamic html (DHTML) and cascade style sheet (CSS). Thus the graphs become part of the web page. This is necessary if the user want to print the graph and web page on the same paper.

Beside of recording voice, drawing, text and images, the system also record the events from the actions of the user during record mode. These events include the scrolling of the web page, popping up and pushing down of the sketch whiteboard 233 (refer to FIG. 3) for user to draw FIG. 4, the changing of the pen type, size and color etc. These functions can set by roller control 41, pop-up control 42 or pen type control 43 of the control panel.

The recorded voice is segmented to audio frames of constant duration. The audio frames are compressed by using one of the speech compression algorithms provided by the system. User might choose the speech compression algorithm based on the tradeoff between compression rate and playback speech quality. When the user draws on the web page, the system saves user's drawing as series of “strokes”. A stroke is a sequence of two-dimensional points that are generated by tracing the movement of pen, mouse or any input-device, from the press-down to the release of the device. The system breaks a stroke to many small segments called “stroke frames” for better synchronization with audio frames. When user inserts text or image, the system simply creates text and image frame for the text and image file. Each frame is leaded by a flag (one byte in one realization) to identify the type of the frame to see if it is audio, stroke or others etc.

Since each audio frame occupies a constant time interval decided by the compression algorithm being used, e.g., thirty milliseconds for ITU G.723, the system can determine the time at the point of the stream simply by counting the audio frames ahead of the point. The system then time-multiplex the audio, stroke, text and image frames into a single data stream called audio-graph stream (AGS) for the AG item FIG. 5(a), every frame has a flag F, and may then include in AGS audio frame AF, stroke frame SF, image frame IF or text frame etc.

Beside of the AGS, the system also creates a separate, usually short stream called header stream for the item FIG. 6. The header stream comprises messages that are either information messages (IM) or event messages (EM). A message is composed of one to several fields. The user can add properties such as the title, summary, the name of author, and the address of the web page to the AG item. Some of the properties can be used as the keys for the search engine to search the AG items. The IM is to describe the property of the AG item. An EM is to record the change of the display (window) during record. An EM must have a time field to indicate when the change happens. For example, an EM may be used to indicate when the scrolling of the web page happens and what the new scroll offset is. Or an EM may be used to indicate when an image object is inserted and what the position and the size of the image are etc.

When the user saves the streams of the AG item, the header stream and data stream are saved into a compound file by OLE. The web page being annotated is usually only linked to the AG item, i.e., only the URL address of the web page is saved inside the header stream, not the web page itself. We call this case of the AG item as “linked AG item” FIG. 7(a). However the user has the option to save or embed the web page to the AG compound file. We call this case of the AG item as “embedded AG item” FIG. 7(b). This is necessary when the user want to create a self-contained CD ROM course or wants to enable the offline (without Internet connection) playback of the AG item. In some cases the system will automatically embed the web page to the AG compound file. One case is when the user want to e-mail the AG stream and the annotated web page is located at the local drive, not on a public web site.

The user could organize related AG items to a group called AG course. The AG course is similar to a sequence of slides and contains AG items. One of these AG items is called the root AG item, and the rest are called child AG items FIG. 8(a). The AG course can be either a “c-linked” or “c-embedded”, depending on how the AG course is saved. If the compound files of all the child AG items are saved inside the compound file of the root AG item, then we call the AG course is c-embedded FIG. 8(b). Otherwise, we call it c-linked FIG. 8(c). Note that the root or a child AG item of the AG course could be embedded or linked, depending on the location of its annotated web page discussed above. The reason to make an AG course c-embedded is the same as to make an AG item embedded, i.e. to enable the emailing of the AG course and offers the possibility of offline playback of the AG course.

The system uses a tree to represent AG item and course. Each AG item has a corresponding node on the tree FIG. 9. The tree is multi-leveled. For an AG course, the node of the root AG item is the parent node for all of its child AG items. The node of any AG item could also be a parent node for the so-called “response AG item”. A response AG item is created by the system when an audience responds to the played AG item in the form of audio and graph. The audience or student can send back his response to the author by e-mailing the response AG item. The response AG item contains some information from the original AG item, as well as the audience's audio-graph response.

The node of the tree has a data structure. Some members of the data structure correspond to the IM and EM of the header stream of the AG item, and some are used as state parameters during record and playback. During record, the user is able to edit the existing AG item. Like the MP3 or MPEG stream, the AG stream is a time stream implied by the number of the audio frames. Except by scanning and counting the audio frames from the beginning there is no other way to determine the time position in the stream, since the stroke, text or image frames are not fixed size (bytes). This implies that the manipulation (segmentation and appending) of the data stream or file is both wasting computing resource and time consuming. Therefore the system uses a multi-level event array inside of the data structure for the EM and a set of temporary streams to reduce the frequency of stream manipulation.

Since the AG data stream is usually very large even after compression, it may take a long time to download the compound file from a web site. To enable the download and playback at the same time (called streamed playback), the system segments the AG stream to a number of smaller streams called SDS when it is published to the web site FIG. 5(b). A realization of segmentation is done by limiting the time (audio frames) and the size of a SDS. The information of the number of the segmentation is saved in the header stream. The name of the SDS is also defined by the system such as data_{—}0001, data_{—}0002 etc. When the AG item is published, the system will upload the header stream and the SDSs to the location (folder) given by the user.

The system provides an ActiveX control (or plug-in) to be put in the published web page. Whenever the audience or student click on the control (it could be in the form of hyperlink on the web page) to invoke the system or simply by file extension association, The system can get the location of the header and SDS streams passed by the ActiveX control. The invoked system starts to download the usually short, header stream. Once the header stream is received, the system knows the location of SDS and URL of the annotated web page, if there is one. It starts to download the first SDS and the web page. Once the web page and the first SDS are downloaded, the system starts to play the first SDS, and at the same time the system continue to download the following SDSs. The audience or student only has to wait for the annotated web page and the first SDS downloaded before seeing the playback. If the size of the SDS is limited about two hundreds kilobytes, the waiting time is about fifteen to twenty seconds over a 56 k modem, even when the total time of the AG item is several hours. Thus the segmentation of AG stream reduces the buffering delay of playback of the AG item. There are other benefits of using segmentation. First, there is no need of special server code installed on the web site to enable streamed playback. Second, the web site is truly platform independent, i.e., it can be a Window NT IIS or any Unix based web server.

The system provides means for interaction and dynamical editing. For example, during playback, no matter the played item is local (e-mail) or remote (web site), the user is able to respond to the played item with the form of audio-graph, as mentioned above as an response AG item. If the played item is local, the user can dynamically switch to record, edit, or even delete part of stream.

The present invention may best be understood through the following description with reference to the accompanying drawings, in which:

### BRIEF DESCRIPTION OF THE DRAWINGS

FIG. 1: The example of traditional slides presentation lecturing.

FIG. 2(a): The whiteboard diagram of present invention's better invoked example.

FIG. 2(b): The web page with transparent windows diagram of present invention's better invoked example.

FIG. 3: The pop-up drawing panel diagram of present invention's better invoked example.

FIG. 4: The control panel diagram of present invention's better invoked example.

FIG. 5(a): The AG stream diagram of present invention's better invoked example.

FIG. 5(b): The diagram of AG stream that is segmented into several SDS of present invention's better invoked example.

FIG. 6: The header stream diagram of present invention's better invoked example.

FIG. 7(a): The web linkage diagram of present invention's better invoked example.

FIG. 7(b): The embedded web page diagram of present invention's better invoked example.

FIG. 8(a): The AG course diagram of present invention's better invoked example.

FIG. 8(b): The C embedded AG course diagram of present invention's better invoked example.

FIG. 8(c): The C linkage AG course diagram of present invention's better invoked example.

FIG. 9: The data structure of present invention's better invoked example.

FIG. 10: The user end's computer structure of present invention's better invoked example.

FIG. 11: The mode transfer of present invention's better invoked example.

FIG. 12(a): The diagram of inserting stroke frames into data streams of present invention's better invoked example.

FIG. 12(b): The content of stroke frame of present invention's better invoked example.

FIG. 13: The data stream and event array of present invention's better invoked example.

FIG. 14: The graphics user interface at idle state of present invention's better invoked example.

FIG. 15: The characteristics dialog box of present invention's better invoked example.

FIG. 16: The graphics user interface of recording sub-system of present invention's better invoked example.

FIG. 17: The graphics user interface of playback sub-system of present invention's better invoked example.

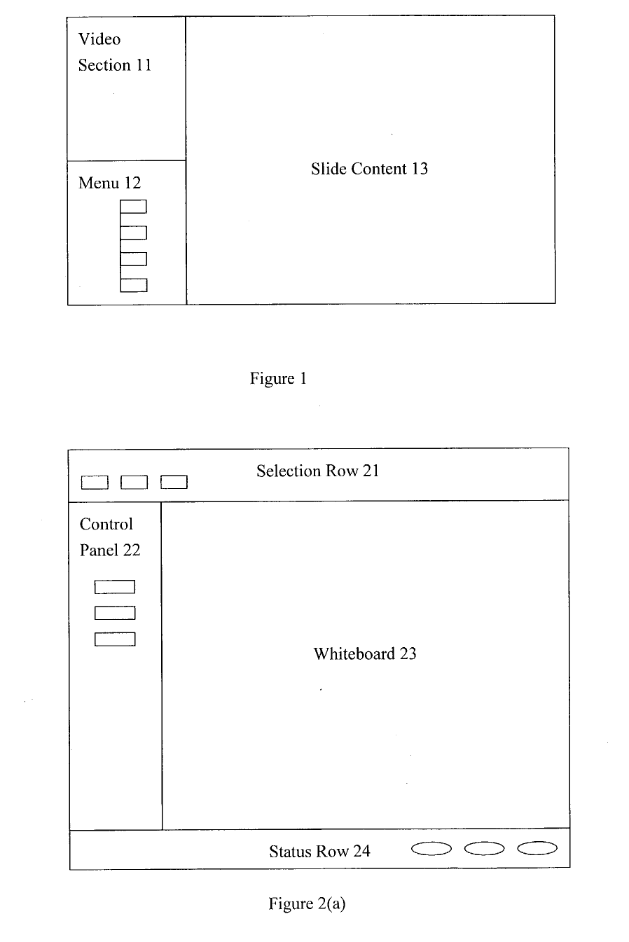

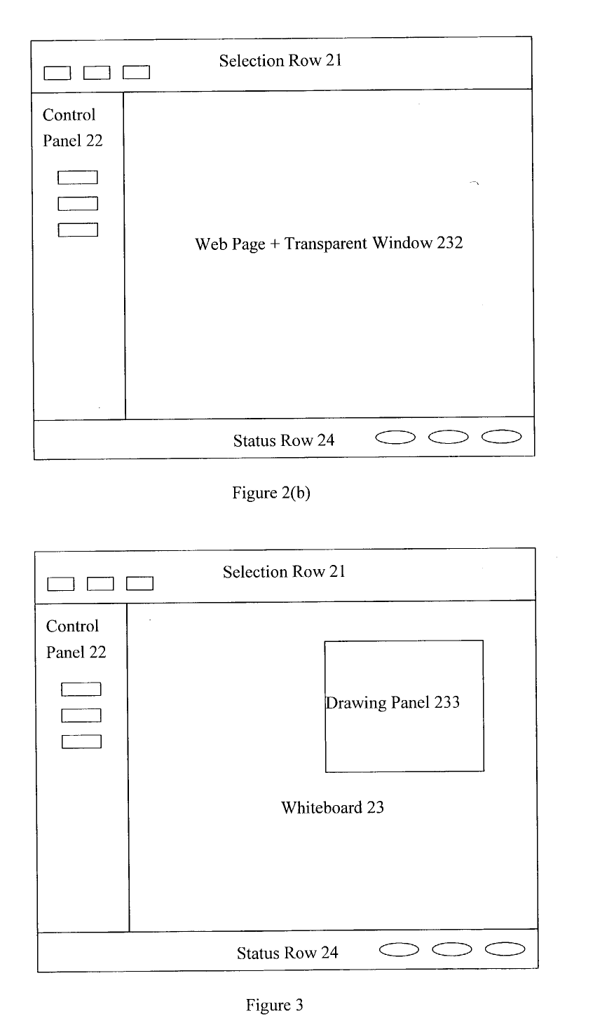

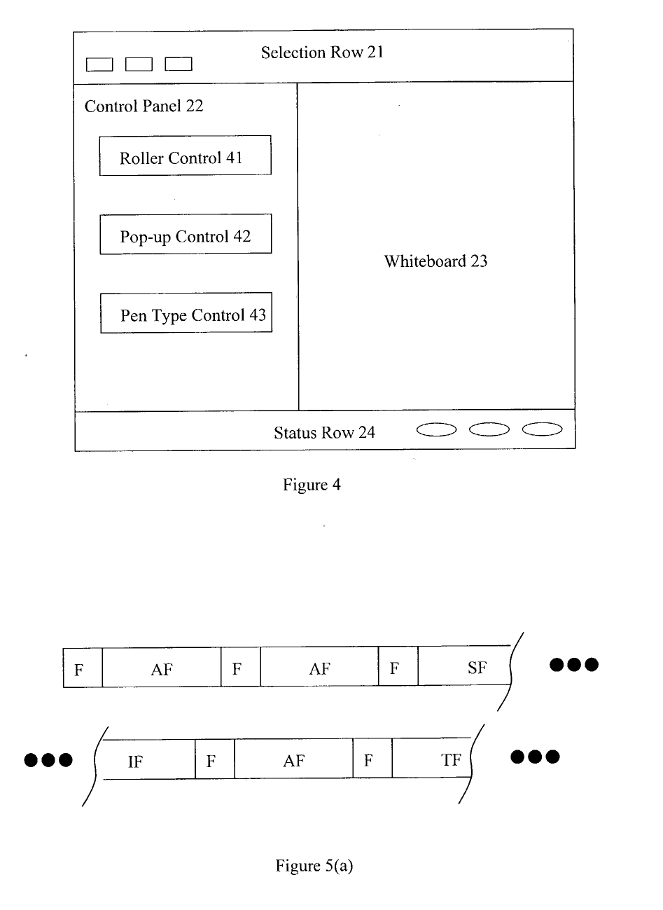

| | |
|---|---|
| 11: Video Section | 12: Menu |
| 13: Slide Content | 21: Selection Row |
| 22: Control Panel | 23: WhiteBoard |
| 24: Status Row | |
| 232: Web Page + Transparent Window | |
| 233: Drawing Panel | 41: Roller Control |
| 42: Pop-up Control | 43: Pen Type Control |
| F: Flag | AF: Audio Frame |
| SF: Strobe Frame | IF: Image Frame |
| TF: Text Frame | AGS: Audio-graph (data) stream |
| SDS: Segmented Data Stream | |
| 100: CPU | 101: Memory |
| 102: Hard Disk | 103: Sound Card |
| 104: Keyboard | 105: Mouse |
| 106: Network Interface Card | |

### DETAILED DESCRIPTION OF THE PREFERRED EMBODIMENT

System Setup

Hardware Requirement

The hardware requirement for the present invention is shown in FIG. 10. The hardware system comprises a central processing unit 100, an internal memory 101, a storage device such as a hard drive 102, a sound card with microphone input and speaker output 103, a keyboard 104, a mouse 105 or a pen-input device such as a pen tablet. If the user wants to play back the AG stream of the present invention from a web site, a network interface card 106 or a modem is needed also.

Note that it is better to use pen-input device rather than the mouse to draw. The reason is that the pen device has much higher sampling rate than the mouse does, thus it produces smoother and less zigzagged lines. Furthermore, many pen devices are pressure-sensitive. The pressure can be used to determine the thickness of the stroke in the present invention.

The above hardware system is used for authoring, editing and playback of the AG stream. We call it the client system in the present invention.

If the AG stream is to be put on a web site for others to download and play back, a server system is needed. The server could be a computer and operating system that provides the HTTP and FTP services, where the HTTP is used for stream download and FTP is used for stream upload. Unlike many other streaming technologies that require special stream media service to be installed on the server and only works under special operating system, the present invention doesn't need special service to be installed on the server and is platform independent. Usually the user can outsource the service to a web hosting company. It is not necessary to set up the server in house.

The following discussion is mainly on the client system.

Software Requirement

The present invention is a software system that is built on the top of an operating system that provide primitive graph, sound and some necessary capabilities. Since the invention needs services to download and upload the stream from the web site, the operating system needs to provide HTTP client, FTP client and E-Mail (SMTP and POP) client service. The present invention also requires embedding a web browser control (in this case, the operating system needs to have a web browser with dynamical html (DHTML) capability), or the implementation of the present invention needs to provide its own web browser to display a web page for annotation.

As an example, if we use Microsoft Windows as the operating system and Explorer as the web browser, one can implement the present invention as a “container” application under the ActiveX or OLE terminology. In this embodiment the present invention is a container that host a “web-browser” ActiveX control exposed by the Explorer.

Detail of the Invention

The present invention is mainly a software application. When we say the system in the following, it means the software component of the client system mentioned above.

Introduction of the System

Here we give a brief introduction to the subjects that will be discussed in detail.

Operation Modes: Idle, Record and Playback

First the system is operated in one of three modes: idle, record and playback. The transitions between the three modes are shown in FIG. 11. The system is divided into three subsystems. Each subsystem corresponds to each mode and has its own graphic user interface, GUI.

The system normally starts with the idle mode, unless it could be invoked by the ActiveX control on the published web page. In later case the system will start with playback mode to play back the online streams.

The system enters record mode from the idle mode when the user presses the record button. Likewise is from the idle to playback mode. The system could directly enter record mode from playback mode. This happens when the user wants to edit or insert new stream to the existing stream, or create a new stream, which responds to the original stream during playback as show in FIG. 11(b).

AG item, Audio-Graph (Data) Stream (AGS), Header Stream

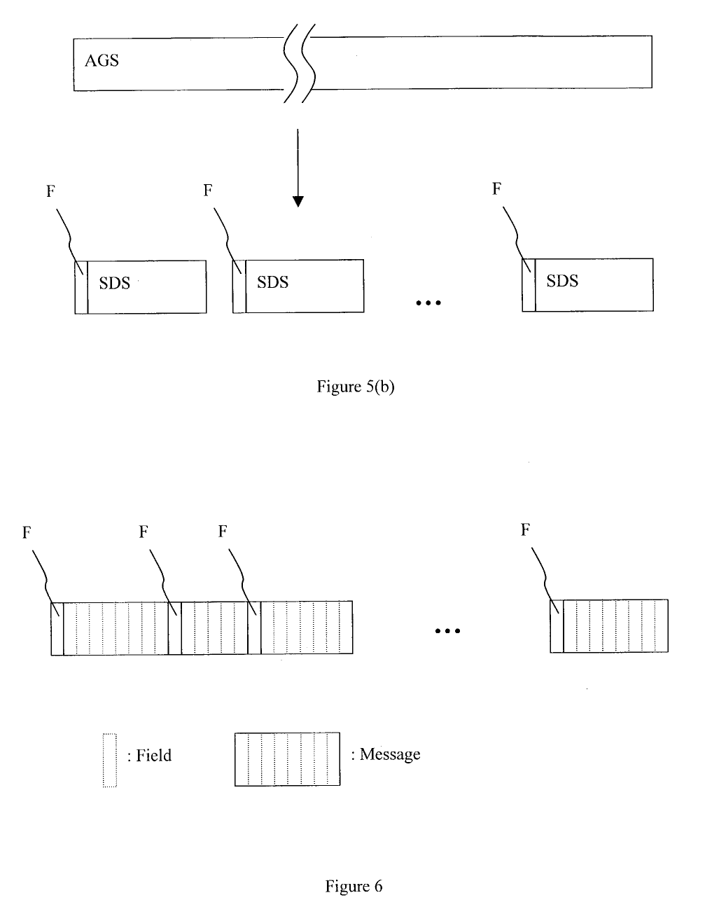

The item annotated is called AG item, since the data is mainly composed of audio and drawing graph (however it can also contains texts and images). The system creates at least two streams for an AG item. The usually very large stream called the audio-graph (data) stream (AGS) that comprises audio, stroke, text and image frames as shown in FIG. 5(a). Each frame has a flag for identification of its type. Another stream called header stream is used to describe the attributes of the stream and the events generated during the record FIG. 6.

AG File, Course, Tree and Data Structure

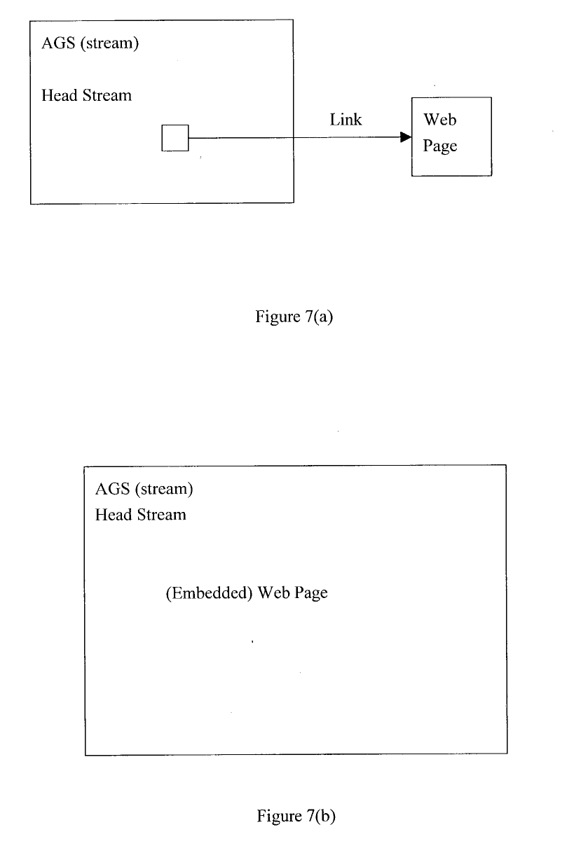

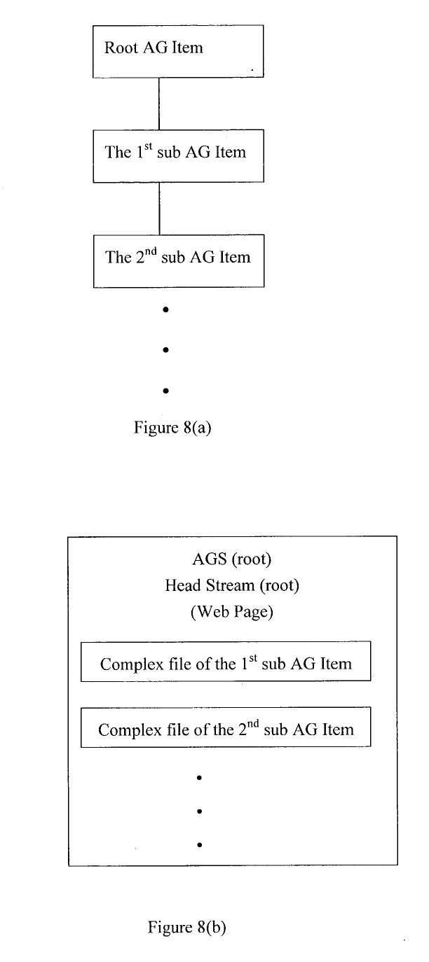

The two streams and possibly the annotated web page are saved into a compound file called AG file for the AG item FIGS. 7(a) & 7(b). The user can organize a group of AG items to an AG course. One of the AG items in the AG course is called the root AG item and the rest are called child AG items FIG. 8(a). The AG file of the root AG item may contain AG files of its companion child AG items as discussed later FIG. 8(b) & FIG. 8(c).

The system uses a tree structure to represent AG items. A node of the tree is corresponding to an AG item. Each node has a data structure in which some of the members represent the states during record and playback, and some represent the attributes and the events of the AG item.

Definition of Terminologies

AG item: The targeted web page or whiteboard being annotated.

Embedded AG item: The AG item that the annotated web page is saved inside the compound file with the other streams (header and data).

Linked AG item: The AG item that the annotated web page is not saved inside the compound file. However the URL or address of the annotated web page is saved inside the header stream.

AG file: the compound file of the AG item that is composed of the data stream (AGS), header stream, and possibly the web page (if the item is embedded) and possibly the compound files of its companion child AG item if the item is the root AG item of a AG course.

AGS, audio-graph stream: a multiplexed stream with audio, stroke, text and image frames.

AG header stream: a stream of the AG item that is composed of information messages for the attributes of the AG item, and event messages for the events occurred during the record.

Information message (IM): One of two types of messages in the header stream that comprises of the attributes of the AG item, such as the title of the AG item, and the author etc.

Event message (EM): One of the two types of messages in the header stream that comprises of the events such as the scrolling of the web page, during record.

AG course: a collection of AG item that can be playback, distributed, emailed as a single unit. One of these AG items is called root AG item and the rest are called child AG items.

Root AG item: one particular AG item of the AG course. The information about the AG course, such as its composition and order of all AG items, is saved into the AG file of the root AG item.

Child AG item: the AG item of the AG course and is not the root AG item. i.e., it doesn't contains information about the AG course and is just like a normal AG item.

C-Embedded AG course: An AG course that the compound file of the root AG item contains all the compound files of its companion child AG items of the AG course.

C-linked AG course: An AG course which is not a c-embedded AG course.

Response AG item: When the user wants to respond to a currently played back AG item to the author, he could create a response AG item that has obtain initial graph from the displaying part of graph of the original stream. Some attributes of the response AG item are inherited from the original AG item. The node of the response AG item is a child of the original AG item.

Segmented AG data stream (SDS): In order to enable the delay-less playback of a large stream from a web site, the AGS is actually segmented into many smaller AGS. These smaller AGS is called SDS.

Composition of AG File

Each AG item has a corresponding AG file; it could be temporary if the user doesn't explicitly save the file. An AG file is a compound file by the terminology of OLE. A compound file can be viewed as “file in file” system. By OLE terminology, a file stored in the compound file is called a stream and a folder stored in the compound file is called storage as shown in FIG. 7(c). Note a stream in a compound file could be a compound file itself.

The composition of AG file is dependent on the type of AG item. First, for the case that the AG item is a non-root AG item, then there is two possibilities. If the AG file contains only data stream (AGS) and header stream, it is called a “linked” AG item FIG. 7(a). On the other hand, if the AG file contains not only the two streams but also the web page and possibly the components linked by the web page, then it is called an “embedded” AG item FIG. 7(b).

Second, if the AG item is a root AG item of an AG course. It could be an embedded or linked just like other AG items determined by the location of the web page. Besides this, a root AG item can be further distinguished by the following. If compound files of all of its companion child AG items are also saved inside the compound file of the root AG item, then the root AG item is called a “c-embedded” root AG item FIG. 8b. Otherwise it is called a “c-linked” root AG item FIG. 8(b).

Composition of AG Data Stream (AGS)

The data generated during record is called AG data stream (AGS) FIG. 5(a). It is a multimedia stream that comprises different kinds of data frames. The data frames are synchronously mixed together. Each frame of the AGS has a frame flag at the beginning for identifying the type of frame. There are four basic types of data frames defined in the present invention: audio, stroke, text and image frames. However it is possible and straightforward to add new types of data frames, such as hyperlinks and video, in the future extension.

Each audio frame, which is compressed, has fixed time duration that depends on the audio compression algorithm. But it may not have fixed length. Therefore the AGS is actually a time stream. The time at any position of stream can be determined by counting the number of audio frames ahead of the position.

A frame is composed of fields FIG. 6. The frame syntax is type-dependent. The first field of any frame is the flag of identification.

Frames are interleaved. The playback subsystem uses the count of audio frames to timing the audio decoder and displaying the drawing, text and images. For example, the stroke frames between n and n+1 audio frames will be displayed at the time of nD and (n+1)D, where D is the duration of the audio frame.

Frame Syntax

Audio Frame

Flag

Compressed audio segment (might be varying size)

During record the system receives the raw audio frame (sampled, digital, and non-compressed) from the sound card. The raw audio frame has fixed length and fixed duration. The record subsystem compresses each raw audio frame to (compressed) audio frame by using an audio compression algorithm. For example if the system uses the ITU G.723 CELP-based standard for audio compression, a raw audio frame has the length of 480 bytes with duration of 30 milliseconds. The sampling rate is 8 k per second and each sample is 16 bits PCM format. Each raw audio frame is compressed to 4 bytes, 20 bytes or 24 bytes that are corresponding to the modes of silence, high and low rate of G.723 respectively. Thus the compression rate is 24:1 (5.3 k bits/second) for high rate and 20:1 (6.3 k bits/second) for low rate. Note that G.723 is a “lossy” compression algorithm. This means that fidelity of the audio has been sacrificed and cannot be fully recovered by the decoder.

There are a few considerations regarding choosing audio compression algorithm. Most of high rate compression algorithms need lots of computing power and memory. Hence it needs high performance computer to compress audio in real time. In some case the pre-filtering, such as noise reduction, of raw audio frame might be required before compression. This also adds load to real-time computing. Thus for the case of faster computer, the compression and pre-filtering could be implemented in real-time. The raw audio frame is compressed and time-multiplexed with other type of frames, mainly stroke frames directly to AGS.

On the other hand, for the case of a slow computer, the system cannot use the real-time compression. The system could save the raw frames to a temporary stream A, and time-multiplex the audio flag (only) with other type of frames to another temporary stream B. The compression and mixing of A and B to the AGS can be done later. We will discuss when the compression and multiplexing should be done in the section of record subsystem.

Note that the frame format could be changed if other type of compression algorithm is used. The information of which audio compression algorithm is used is saved in the header stream.

Stroke Frame

Flag_S or Flag_R

Number of points

Pen type

Pen color

Pen size

(x,y) . . . or (x,y,p)

The system allows the user to draw directly on the white board or on the transparent window that covers the web page to make graph annotation. Unlike some “illustrated audio stream” that only simple geometry of drawing is allowed and the drawing is saved as meta data (instruction of drawing), the drawings of the present invention are recorded as strokes. A stroke is defined as a series of two-dimensional points, and it starts from the location where the input-device is pressed down to the location where it is released.

The two-dimensional point (x,y) is horizontal and vertical coordinate of point relative to the web page, not to the display (window). For example, with a window size of 800*600, the web page could well exceed that size (thus has scroll bar) i.e., the x value larger than 800, or y value larger than 600.

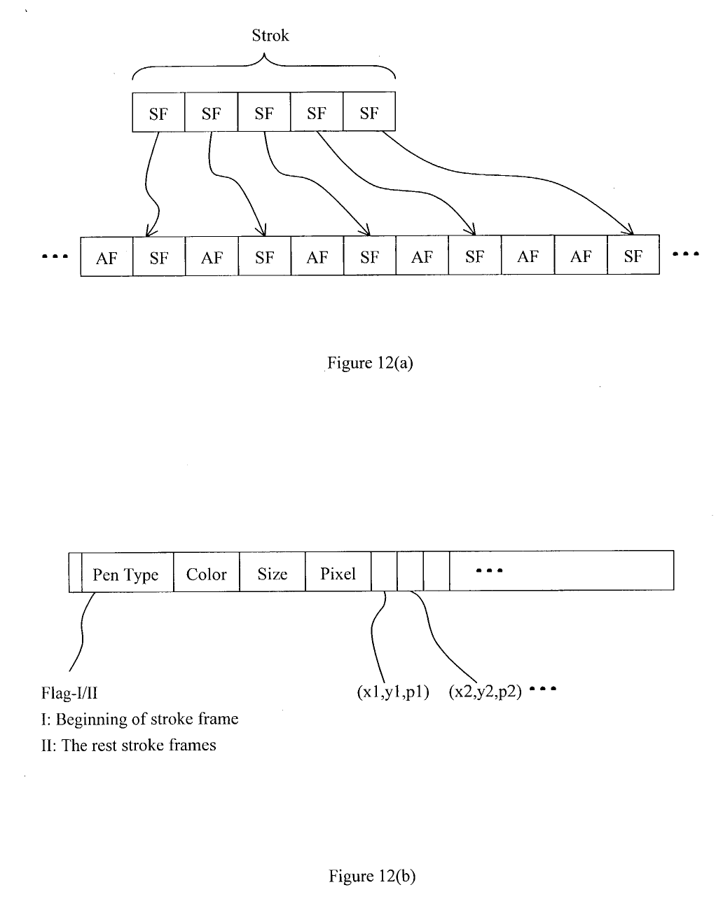

In order to have better synchronization with the audio, the system segments a stroke to many smaller stroke frames before mixing with audio frames FIG. 12a. For example, if the user draws a stroke for thirty seconds, and if there is no segmentation of the stroke, the 30 seconds stroke will be decoded and displayed by the time of single audio frame (e.g., 30 ms for G.723). It would be preferred if the stroke is equally distributed in the 30 second of audio frames (e.g., about 1000 frames). Another reason to segment stroke is to reduce the size of buffer of storing a single stroke.

In the realization one can put the limit on the size of stroke frame. The smaller size of stroke frame has better synchronization with audio and requires fewer buffers. But it also demands more computing power and increasing complexity.

Beside of the (x,y) points, a stroke frame also contains attributes of input device. The attributes include the pen type, pen color and pen size. The pen type can be a one of solid (fully opaque), marker (fully transparent, with bit-wise AND operation with the background), alpha-transparent (with varying transparency from 1 to 255 for example). One can use −1 for solid, 0 for marker and 1 to 255 for alpha-transparency for the implementation. The pen color is in the form of RGB. Where R is red, G is green and B is blue. Each is an integer value. The pen size is the thickness of the pen.

The above attributes are applied to all of the points of the stroke frame. In the case when the input-device can detect the pressure, the value of the pressure could be added to the (x,y). The pressure p combined with the pen size attribute can be used to control the relative thickness at point (x,y). Using the point-wise, adjustable thickness can improve the rendering quality of the stroke FIG. 12(b).

The system uses two flags for the stroke frame, one is the Flag_S to indicate that this is the start frame of a stroke, and the other, Flag_R, is used for the rest of frames. This distinguishing is important for stroke rendering in the playback subsystem. When the system decodes and displays the strokes, the system connects the points of the stroke frame by line or high-order interpolation function, such as Beizier curve. One might also implement anti-aliasing filtering to the lines to reduce the zigzag effect. The two consecutive stroke frames that belong to the same stroke will be connected end-to-head. Note since the system allow the user to draw on the web page, as well as on the sketch board, there is a different set of (Flag_S, Flag_R) for the drawing on the sketch board.

One may also compress the space points by exploring the approximation of consecutive points in the stroke. Since the consecutive points are usually close in space, one may represent a stroke by (x_{—}0,y_{—}0), (x_{—}1−x_{—}0, y_{—}1−y_{—}0), (x_{—}2−x_{—}1,y_{—}2−y_{—}1) . . . instead of (x_{—}0,y_{—}0), (x_{—}1, y_{—}1), (x_{—}2, y_{—}2) . . . . The benefit of doing this is that we can use fewer bits to code the difference of vectors by using loss-less codec such as Huffman codec. Since there is high probability that x_k−x_k−1 is very close, and we can design a codebook to represent the delta value. For example, the codebook may looks like

| Delta | code |
|---|---|
| 0 | 0 |
| 1 | 10 |
| 2 | 11 |
| 3 | 100 |
| 4 | 101 |
| 5 | . . . |

Thus the system is able to use fewer bits for the smaller difference that happens more often. However the codec certainly increases complexity of computing.

Text Frame

Flag

Object ID

Flag to insert or delete

Bounding Rectangle

Font ID

Text Size

Number of bytes of text

Text . . . (It could be empty, if it is to delete, or the object has been existed before)

During record the user may place text on the white board or on the transparent window that covers the web page dynamically. When the user defines an area on the transparent window, he can enter the text with chosen font type and size. Or the user may place the existing text box on the window and move it around. The text box has a boundary rectangle relative to the underline web page. Although it is not placed into the web page during record, the user may request to really insert the text into the web page by using DHTML, CSS and z indexing.

The parameters in the text frame are self-explained. The text box or object has an id. The event of inserting or deleting the text object is saved as an event message of (time, object id, Flag of insert or delete, Bounding Rectangle) in the header stream. It looks like the information is duplicated in data and header stream. The duplicated information in header stream is important for improving the performance of playback subsystem that will be discussed later.

If the frame is to delete the existing text object, then the number of bytes of text is zero. Or if the text object exists before, then there is no need to duplicate the text.

Image Frame

Flag

Object ID

Flag to insert or delete

Bounding Rectangle

Type of image (e.g. 0 for jpeg, 1 for gif, 2 for png, 3 for tiff . . . )

Number of bytes of image file

Image file

The user can also insert or delete an image object on the white board or on the transparent window that covers the web page dynamically. The image files can be any compressed image files, either loss-less as gif or png, or lossy as jpeg. The discussion about the text object is applied to image object too.

The text frame and image frame are generally not segmented, it would appear instantly when the playback receive the objects.

Other Possible Extension

Beside of the above four types of frames, It is possible to add other type of frames to the stream by specifying different flags. For example, one might add a “pause frame” that tell how long playback subsystem to pause to continue, or one might add a “hyperlink frame” that specify the url address of a hyperlink that the students can access during playback. Or in the future when broadband is common; one is able to add “video frame” that synchronously mix with audio and other type of frame to create a real video-on-demand system.

Segmented Data Stream (SDS)

Since the data stream AGS contains audio and graph frames, the stream (file) size is usually very large. When the stream is placed on the web site, it would be unacceptable to wait for the whole stream to be downloaded before the playback, especially for a slow Internet connection. Thus it is desirable that one can download and play back the stream at the same time, or at least the delay can be minimized. Unfortunately the functions provided by most of operating system to download the file are blocking functions. For the example of Microsoft Windows, one can use FTP-based API's ISAPI or HTTP-based API such as “Imoniker” or “UrlFileDownload” to download a file from any web site. However these functions are blocking function, i.e. the function won't return until the file is downloaded. Note that it would be better to use HTTP based to download instead of FTP. Since some FTP servers use proxy (firewall), it is not easy to implement a general enough FTP client to get through the firewall. Although one might implement his own FTP or HTTP client to avoid the blocking problem, the cost and the time to implement these function is not justifiable, and the user might need to update once the protocol changes. It would be wise to let operating system handle these low-level functions.

Therefore the present invention use simple segmentation algorithm to solve this problem.

Before the stream is uploaded to the web site, the system could segment the data stream AGS to many smaller size of stream called segmented data streams SDS FIG. 5b. Each SDS can be either limited by size or by its duration of time. As an example, one may choose to limit the duration of a SDS less than two-minute. The number of the SDS and the name of SDS are stored in the header stream. The name is actually a prefix only. The names of SDSs could be as “data_{—}0001.xxx”, “data_{—}0002.xxx” etc. (xxx can be anything)

After the header stream and SDSs are uploaded to a web site, the playback subsystem can use blocking URL function to download these files. The playback subsystem first downloads the header stream. From the header stream, the playback subsystem knows the number of the SDS and the prefix of the stream names. Then it starts to download all the SDS sequentially. At the same time when the first SDS is downloaded, the playback of stream starts. Thus the system is actually playing back the stream while download the stream at the same time. The delay is just the time to wait for the header stream and first SDS to be downloaded, which in most of case is less than thirty seconds even on a slow Internet connection.

On more benefit to use simple segmentation algorithm is that there is no special server code needed on the web server. Unlike some other streaming media that need special server such as Window IIS media server, the present invention could use any web server, no matter is Unix or Window NT, to publish the SDSs and the cost is very low.

Composition of AG Header Stream

Beside of the data stream the system also generates another stream called header steam during record. The header stream is the first stream to be downloaded before any SDS when it is played back from a web site, and thus it is called “header” stream FIG. 6.

There are two types of messages (information) in the header stream. One type is called information message (IM) and the other is called event message (EM). The information messages are about the attributes of the AG item and are used to describe the item. The event messages are produced during record. During record, the user creates events beside of the data stream. It is necessary for the playback subsystem to know the events in order to fully replicate the recording process. An event could have many event parameters. A common parameter to all events is the time, more accurately the audio counts, when the event occurs.

Each message in the header stream occupies several fields as FIG. 6. The first field of any message is the id (flag) field to identify the type of the message. For examples, a title message (an IM) has two fields. One is id (e.g. 0000) and the other is the text string of the title; A URL message (an IM) that is used for the URL address of the annotated web page could have two fields too. One is id (e.g. 0001) and the other is the text string of the URL. Another example, the scrolling event (EM) could have four fields: one is id (e.g. 1000), one is the audio frame counts (before the scrolling event occurs), one is the x-offset, and last is the y-offset.

Note that in real implementation, the messages of the header stream is usually stored as state members of the data structure that represent the AG item; the system will generate the header stream only when the user is saving, e-mail, or uploading the AG item. Similarly once the header stream is received by the playback subsystem, it is decoded and saved as state members of data structure.

In the embodiment of the present invention, the header stream can be just a long text string. Fields are separated by some special symbols.

The following is the detail of each message.

Information Messages

The information messages are the attributes of the AG item or course. The followings are the names and formats of some IMs.

Version (the version of the stream format): Flag, Version number

Type of AG item: Flag, type (normal AG item, root AG item, child AG item, response AG item, delta AG item etc.)

Title: Flag, title

Author: Flag, name

Date: Flag, date

Comment: Flag, comment

Audio codec: Flag, codec ID

URL of web page: Flag, URL (empty if whiteboard and embedded)

Embedded or linked: Flag, type

Font id of web page: Flag, font id

Text size of web page: Flag, text size

Target screen size: flag, size (e.g., 1024*768)

Total time (audio counts): Flag, counts

Number of segments: Flag, number

Number of companion child AG items: Flag, number (only for root AG item)

Title of first child AG item: Flag, title (only for root AG item)

Title of second child AG item: Flag, title( . . . )

. . .

. . .

Most of IM are self-explained. Some needs more explanation.

The version number is for the stream format. If the format of stream changes, the system might give a new version number to distinguish it from the old format. The delta AG item is similar to response AG item, but it intends to be inserted into an existing AG item (i.e., the changed part is saved into delta AG item to avoid the duplication while editing).

The target screen size is important for rendering the web page. The content of web page could reformat by the browser when the container window is resized. Thus if the window size is different in recording and in playback, the annotation on the web page will not match in position. Thus the system saves the screen size information in the header stream and the playback subsystem can use this adjust the display window accordingly. The size of screen also affects the scrolling of the web page. It is wise that keep the screen size around 800*600, since the size of most of monitor is above that size.

If the item is a root AG item, there are messages for the number, order and titles of its companion child AG items. The reason to specify these is to let the playback subsystem displayed the content of AG course even before child AG items are downloaded, thus the user is able to jump to particular child AG item and start playing back from that (the playback subsystem will switch to get the stream of the selected child AG item).

There are three characteristics about the header stream format. First, the order of messages is not important since each message has flag for identification. Second, The system can easily add more messages by defining different flag. Third, there could be messages that are the same type and thus have same flag. For example, the title message of companion child AG item for a root AG item.

Event Messages

The basic difference of event message from the information message is that event message must have one time parameter. The IM is about the attribute of the item; the EM is about the change of the display (window). The followings are some of the EM.

Scroll: Flag, time (audio counts), frame id, offset-x, offset-y

Sketch board on and off: Flag, time, on or off

Image event: Flag, time, image ID, id, image type, image on or off, bounding rectangle

Text event: Flag, time, text ID, id, font size, text size, text on or off, bounding rectangle

. . .

As mentioned previously some information in event is duplicated in the data stream. The question is why need to put these in event message or why not put all of event message inside the data stream.

The reason is the following. The size of web page is often larger than the display window (most monitor has resolution size less than 1024*768). Thus the browser provides scroll bar that user can use to scroll to given position of the web page. In the present invention, the user could draw everywhere on the web page, and thus we have scrolling events. Suppose that the user wants to play back from the middle of the data stream say time T-mid, instead of from the beginning. If the playback subsystem doesn't know the scrolling offset at T-mid before scanning the data stream, then the system doesn't know whether it needs to draw the encountered stroke frame on the window or not. Remember that the stroke frame contains two-dimensional points that are absolute coordinates to the web page. On the other hand, if the system knows the scroll offset at time T-mid, it can make the decision to draw the stroke frame or not by checking if the boundary rectangle of the stroke frame intersects with the offset window.

Although one could scan the data stream to find the scroll information at T-mid, if the scroll information is saved inside the data stream. This method is not favored because it takes time to do it especially the size of stream is large (the user won't tolerate it!), and further it is not possible if the stream hasn't been downloaded yet. Thus by using a little memory space (event messages in the header stream), we can greatly improve the performance of system. Similar situations apply to the image and text frame.

Some event messages need more explanation. Recall that a web page might contain many scrollable frames (windows in the web page). During record, the user could scroll the whole web page or any child frame. Thus the system need a frame id to identify which frame needs to be scroll. The frame id is nothing but the order of the system retrieves all the window objects (including web page itself) from the web page. As long as the record subsystem and playback subsystem use the same rule to retrieve the window object. For example of DHTML, on can use interfaces such as “IEnumElementCollecton” and “IEnumElement” and other functions to enumerate the window objects.

Recall that the user could insert image and text objects at some time T1, and delete them at later time T2. The system assigns each image and text object an id (image id or text id) to match with the id in the data stream. However it is possible that there are more than one same images or texts object on the web page at the same time, thus the second id in the event message is used for this purpose.

The event messages don't need to be sorted according to the time, and it allows two more event messages have the same time parameter.

AG Data Structure and Its Implementation Issues

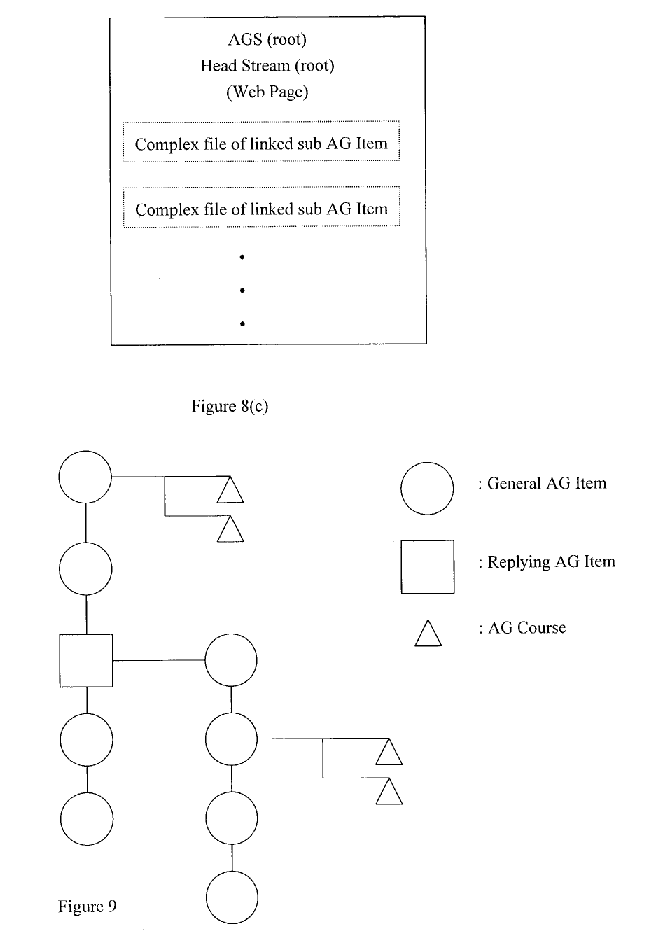

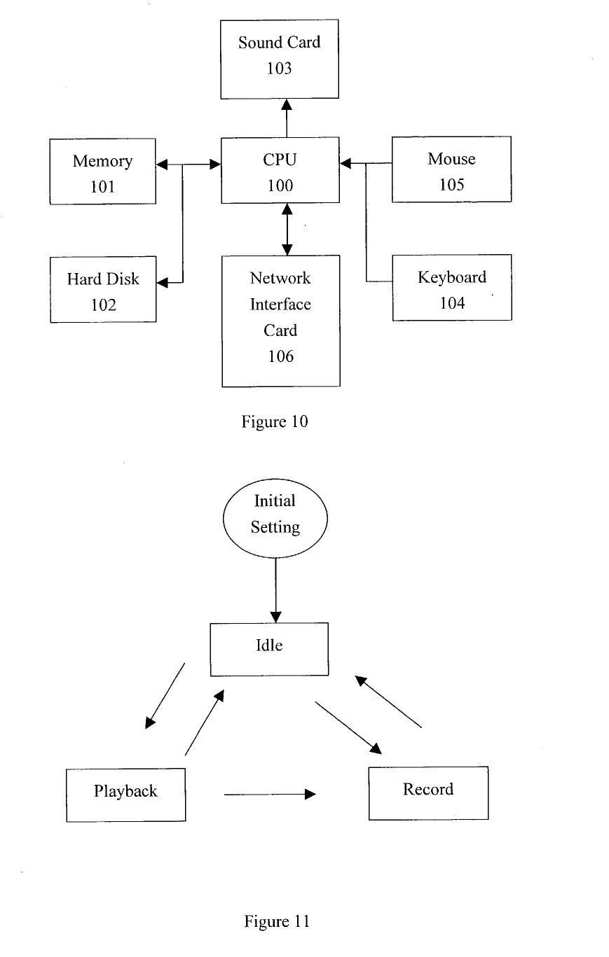

The system uses a tree as shown in FIG. 9 to represent AG items and courses. A node on the tree corresponds to an AG item. The tree is a hierarchy. A node could have children or parent, depending on the type of node. For example, if the node is a root AG item, then the children of the node are the companion child AG items that belong to the same AG course; the response item of an AG item is a child node to the AG item etc.

When the system plays back an AG course, it will play the root AG item of the course first and then the child AG items by the order of the nodes on the tree, unless that the user jumps to any node to start with.

Each node has a data structure called AG data structure. Some members of data structure are the replicate of the IM the header stream. But not every IM has a corresponding member in the data structure. For example, the number of companion child AG items for an AG course could be determined from the tree itself. Some members are the states, such as whether the item is changed, during record and playback.

The most interesting members of an AG data structure are the ones that represent the event messages (EM) of the header stream. These members are called event members of the data structure. The design of event members and using of temporary streams (files) are the important factors to reduce the times that stream (file) manipulation during record as explained in the following.

Event Members and the Mechanization of Reducing the Stream Manipulation During Record

The events that are generated during record are represented as an array (EA) of event members of (t, void*), where t is the time (audio counts) that the event occurs and void * means pointer to an arbitrary structure. The structure is event-dependent. For example, if the event is a scrolling event, the structure looks like

Flag (for scrolling)

Frame ID

X-offset

Y-offset

That is just the scrolling message defined in the header stream. Another example is the sketch board event in which the structure looks like

Flag (for sketch board)

Flag of appearing and disappearing

In fact the system use an array of event arrays (EAA) to represent the events during record. The number of EAs in EAA would be at least larger than three. The reason is the following.

The system allows the user to edit the existing AG data stream. The editing of an AGS means to insert a new AGS to the existing AGS, or to delete a part of AGS from the existing AGS. Because the AGS is a stream involving time, the editing of AGS is not as straightforward as editing a file that doesn't involve time, such as text file or word documentation. Another difficulty of editing the AGS is from the fact that the lengths of frames of an AGS are not fixed. Since the user might change the record time to insert a new piece of audio and graph annotation, it often forces the implementation of the editor to scan through every byte to get to the position of particular inserting time. And then slice the existing AGS to two pieces and append the new AGS to the first one, and then append the remaining second part back. The scanning, slicing, and appending are very costly in term of time and computing resource, especially when the stream is very long. It also common that the user may first choose to insert a new piece of AGS, but he find out that the new piece of AGS is not what he wants so that he want undo it. Therefore it is not wise to insert the new piece of AGS right away. Another problem to add the complication is that in each editing session the user may generate all kinds of events.

In order to reduce the times of stream manipulation and thus improving the performance, the system uses many temporary streams and array of event array to solve the problem.

The idea is as follows. Suppose the user wants to edit an existing AGS. The system has data stream AGS-O (with compressed audio frames) and event array EA-O initially. If the user starts to record audio and graph annotation to insert (from middle of AGS-O) or append (from end of AGS-O), the system always create a new set of temporary stream AGS-T1 (the audio frames may or may not be compressed, depending on if the system implementation of real-time compression or not) and event array EA-T1. If the user stops recording, the pair of (AGS-T1, EA-T1) doesn't merges with the (AGS-O, EA-O) at once. At this time (in idle mode), if the user undoes the last record the system simply discard (AGS-T1, EA-T1). Suppose that the user doesn't delete (AGS-T1, EA-T1) and if the user chooses to continue recoding to append, the system simply create another set of (AGS-T2, EA-T2). Then two situation happen when the user continue to record.

First, if the next recording is to append, then (AGS-T2, EA-T2) is appended to the (AGS-T1, EA-T1). The system creates a new set of (AGS-T2, EA-T2) for recording. Note the appending of stream (file) is straightforward and not time-consuming. The appending of EA-T2 to EA-T1, however, should deserve more consideration. Since some events might cancel each other out. For example, if there is an sketch board appearing event at t1 in EA-T1 and there is an sketch board disappearing event at t2 in EA-T2, and the difference of t1 and t2 are negligible (it is possible!) then these two events should be cancelled each other out during merge. Another example, if there is a scrolling event at t1 in EA-T1 and a scrolling event at t2 in EA-T2, and the difference of t1 and t2 is negligible, it is logic that the scrolling event at t1 should be cancelled, only scrolling event at t2 left.

Second, if the next recording is to insert, then (AGS-T1, EA-T1) will be insert into (AGS-O, EA-O). Note that if the audio frames of AGS-T1 are not compressed yet (the case of late compression), the system will compress and mix with other frames before insertion to AGS-O. The system then creates new (AGS-T1, EA-T1) for recording.

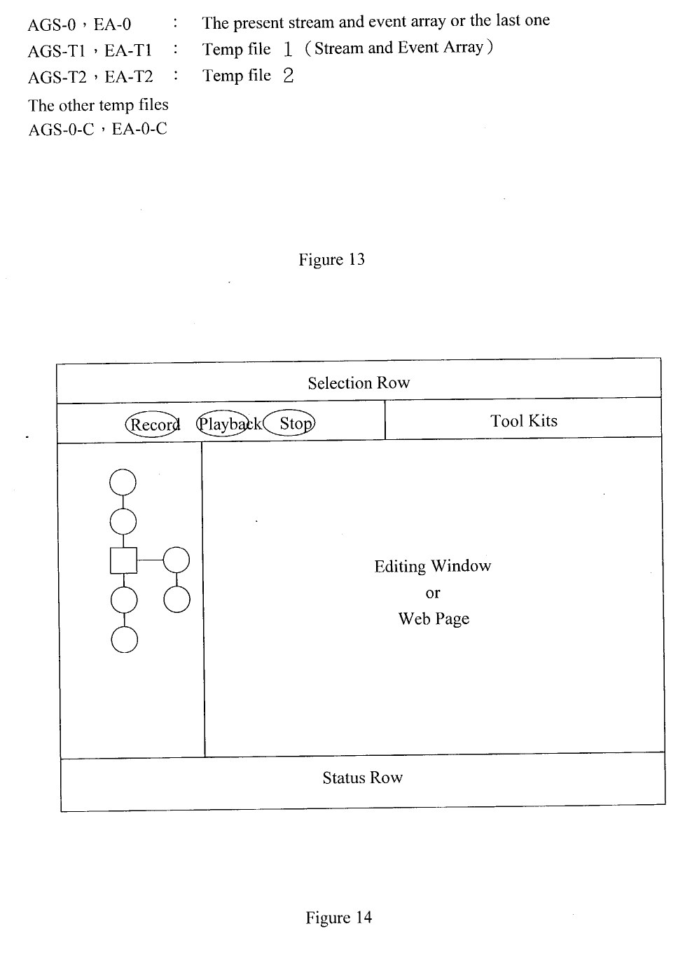

Thus we have three streams (two are temp), and three event arrays as shown in FIG. 13.

Note that the chance to inserting a new piece to the existing one usually has low probability than the chance to appending a new piece to the existing one. It can be imagined that most of time the system simply appending the temp to the existing, and only a few time of inserting the temp to the existing, and thus save the time and computing power and improve the performance of the system.

Of course, we can continue to create temp streams and event arrays for every new recording. But it gets too complexity to generate too many temp files and event arrays and eventually the temp streams and event arrays need to be merged with the old ones. The mechanism used in the system is a tradeoff between complexity and performance.

If one wants to implement the version control of streams, i.e., the modification (delta) and the original streams are saved separately. Then the mechanism can be used too by making initial values of (AGS-O, EA-O) empty. And it may need to define some new members in header stream and data structure to indicate how the modification is going to be (inserting, appending, deletion, where etc.)

The above is for recording. When the user wants to test or play back the recorded stream, one implementation is that the system copies the (AGS-O, EA-O) to (AGS-O-C, EA-O-C) and merges (AGS-T1, EA-T1) and (AGS-T2, EA-T2) to (AGS-O-C, EA-O-C). Thus we have a temp stream (AGS-O-C, EA-O-C) for playback without changing the original stream.

For deletion of part of stream, the user could specify two time-marks to delete stream in between. It could be implemented just like for the playback, that first to create a temp (AGS-O-C, EA-O-C) and then to delete the part of AGS-O-C, and part of EA-O-C. The deletion of EA-O-C needs more consideration similar to the merging. The benefit of this approach is that the user could undo the deletion since the original streams are not affected yet. If the user are sure about the deletion, then the temp (AGS-O-C, EA-O-C) can replace the original one and clear (AGS-T1, EA-T1) and (AGS-T2, EA-T2).

The mechanism proposed in this section certainly is just one way of improving performance during record and testing (playback of recorded stream). There could be many other ways that also can achieve the improvement, depending on the implementation.

Temp Pure Stroke File, Temp Image Files and Text Files and Their Roles for Performance Improvement

During record or playback, the system could generate a pure stroke file. The stroke file is composed of lines of strings. Each string contains the following information.

Stroke occurring time (audio counts)

Boundary rectangle

Stroke points

The file is filled during record, or during playback.

The reason to create this file is to improve the performance of stroke rendering. Recall the stroke frames are mixed with the audio and other types of frames in AGS. If user wants to start record or playback at middle of stream say time T-m, from the event members of data structure the system knows the offset to scroll the white board or web page. If there is no pure stroke file, in order to rendering the strokes on the displayed window, the system has to scan through the data stream, check each encountered stroke frame and calculate its boundary to see if its boundary intersect the currently display window or not, if yes, then show the stroke frame on the window. This processing is very time consuming. If the system already has the pure stroke file, then the system simply read each line of stroke to check if it intersect with the window or not, if yes, show the stroke on the window. Note the system still needs to scan the AGS, however it could jump over the stroke frame without doing anything (remember the stroke frame has a field that indicate the length of the stroke frame, the system simply jump to next frame by that length when it encounter a stroke frame).

Note that there should two such temp pure stroke files, one is for the white board or web page, and the other is for the sketch board.

The system could do the same thing to the image frames and text frames by saving them to separate files.

Although these file might takes lots of space, Using space to improve the system performance could be very worthy, especially that almost every PC today has lots of storage capability.

Operation Modes

The previous several sections are about the format and structure of the streams generated by the system, as well as the AG item's internal structure represented by the node of the tree.

The following discussion is about the operation modes, their user interfaces and implementation. The operations of the system could be in one of three modes: idle, record and playback modes FIG. 11. We also call a system in record mode the record subsystem, similar to the playback and idle subsystem.

Idle Mode and Subsystem

When the user doesn't record or play back an AG item or course, we call the system is in idle mode. The user interface of idle subsystem is shown in FIG. 14. There are menu, tool bar, a tree window and an editing window for a white board or a browser window for a web page.

In most of cases the system starts in the idle mode. The functions that are available during idle mode are:

Browse for web pages, either on local drive or on web sites, to annotate. This is done through the browser control embedded in the system. The system also provide browsing options such as forward, home, load, backward, stop (browsing) and history list as normally seen in any stand-alone web browser such as Microsoft Explorer.

Create a new whiteboard and prepare to edit—record drawing, voice, insertion of image files and text blocks etc.

Load an existing AG item or course to the tree.

Create an AG course by creating a root AG item and drag and drop other AG items to become the children of the root AG item.

Save an AG item or course.

Add and modify attributes of an AG item or course—Note that not all the attributes can be changed by the user. For example, the total time of the AGS is not changeable by the user. The system provides an attributes dialog for the user to add and change the attributes.

Insert the recorded graph, freeform drawing, image and text blocks, into the web page by the help of DHTML and CSS, so that the graph become part of web page for storing and printing—Note that during record, the graphs are actually inserted to a transparent window that cover the web browser window, not directly to the underling web page.

Print

Save a c-linked AG course to a c-embedded AG course.

Organize the tree: change the order of child AG items by using drag and drop, delete a AG item from the tree or course etc.

Create an upload-able AG item or course—the user specifies a location (local or remote) to save the SDS and header stream etc. The system will segment the AGS of an AG item, or all AGS of the root and child AG items of an AG course, and save them to the designated location. Or the header stream and SDSs could be saved into a zip file to distribution.

FTP an AG item or course or post the distributed zip file to a web site.

View record status; such as current play time, record time, and event messages etc.

Delete part of AGS by specifying two time-marks (the time-mark could be defined during playback subsystem)

E-mail an AG item or course—the system might automatically change a linked AG item to a temp embedded AG item before e-mail, if the web page is a local web page. Similar to a c-linked AG course.

Edit e-mail address books, or get it from the e-mail client software installed on the system.

Enter record mode

Enter playback mode

. . .

Beside of these basic functions, the system could easily add other function when it is necessary. Some of the basic functions are explained in detail.

Attribute Dialog

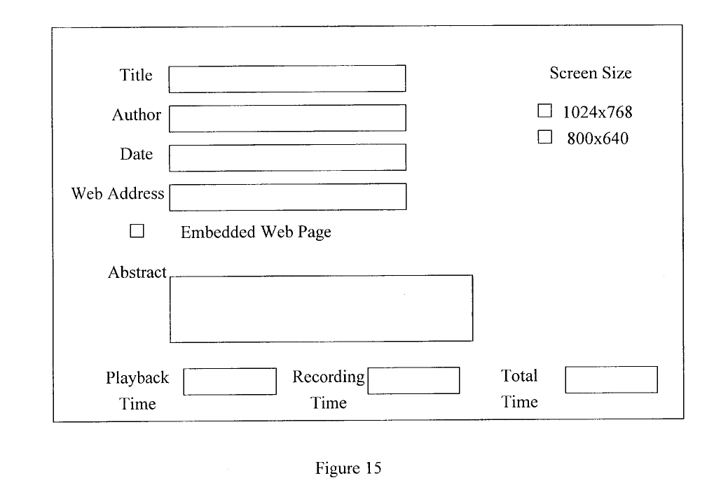

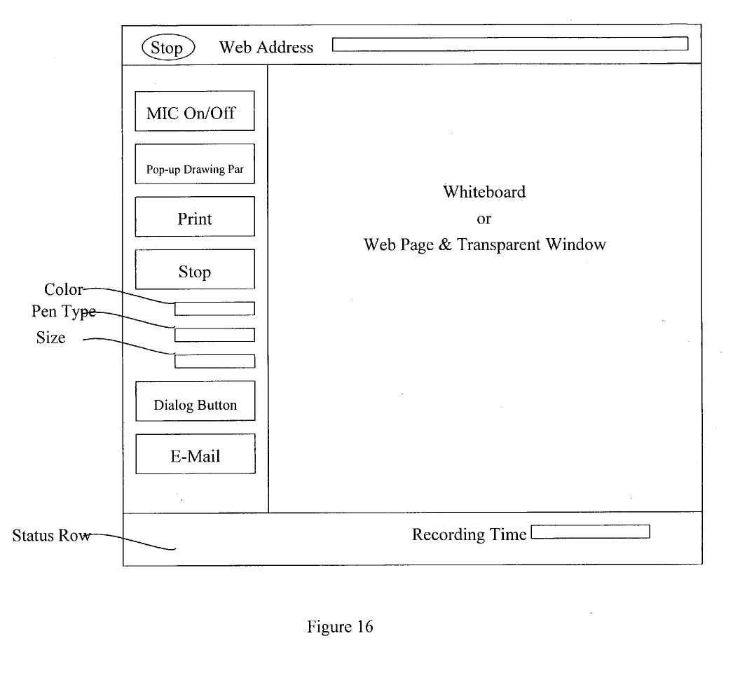

The system provides an attribute dialog FIG. 15 that users could use to add and modify the attribute of an AG item or course. Most attributes of AG items correspond to the information messages of the header stream and are self-explained. In the dialog, the user could specify if the AG item is embedded or linked. If the URL of embedded address is given in the dialog, and the user marks the check box to embed the web page, the system then change the linked AG item to embedded AG item. Note that since a web page could contains many linked components such as images and tables etc, the user has to tell the system where is the folder that contains all the components. Usually the user could save the web page to the local drive by using utility provided by the browser, such as “save as complete” in the Microsoft Explorer, or by some proprietary offline browsers. If the user uses the Microsoft Explorer to save the web page, the web page and its components will be saved as a local web page and a folder (of folder name as “xxx_files”, xxx is the name of the web page) that contains all the components. Be careful that even with most advanced offline browser, some components of the web page still cannot be saved to the local drive. For example, if the components are generated by an ASP code, the Microsoft Explorer then cannot save these components to the local drive. Furthermore, due to security problem, some web site cannot allow some components of their web pages be saved to the local drive.

Insertion of Graphs to the Web Page to and the Graphs Become Part of Web Page

We will explain why the free form drawings are not directly inserted to the annotated web page during record in next section. However it is necessary to insert these graphs to the web page because of two reasons. One is that if the user wants to print the drawing with the web page at same printout, or simply he just want to see the graph annotation with the web page. The other reason is when the user wants to play back the audio narration only and at the same time he is able to control the annotated web page by scrolling, clicking etc.

The insertion is done by first decoding all the stroke frames from the data stream AGS or from the pure stroke file that will be discussed later, and save it into a image file format such as GIF or PNG that the user can specify a transparent color in the image format. Then insert the image to the annotated web page by the technologies of DHTML, CSS and Z-positioning. Similar procedure is applied to insert image and text blocks.

Automatic Creation of an AG Item

An AG item could be created automatically. This happens when user start to record annotation over a new web page. The system simply creates a node on the tree to represent the annotated item.

Automatic Creation of an Embedded AG Item or c-Embedded AG Course

If the AG item is linked and the web page is local, and when the user wants to e-mail the item or upload to a web site, the system will automatically change or copy the item to a temp item that is a embedded AG item, i.e. the web page is saved to the compound file. Similarly, if the AG course is c-linked, then it would be notified to change root AG item and all child AG items to embedded, and save compound files of all companion child AG item to the compound file of the root AG item.

Record Mode and Subsystem

There are two ways that the system enters the record mode. First, the user could press the record button on the menu or tool bar to start record. Or the user could directly switch to record mode while playing back the stream. The user interface of the record subsystem is shown in FIG. 16. There are tool bar (top and left), editing window (white board) or browser window (web page), and status bar.

If the user wants to record audio and graph (drawing, image and text) on a web page, the system actually cover the web page with a transparent window. All the graphs are displayed on the transparent window. Since the window is transparent, the graph looks like directly drawn on the underlying web page. The reason to use the transparent window instead of directly inserting graph into the web page is the following. Although we might write a script routine that detects the mouse or pen movement, and the routine can use the information to “draw” on the web page dynamically, there are many problems with this approach.

First, some parts of the web page, such as hyperlinks, have already responsive to the mouse click and movement.

Second, the script routine needs to call functions provided by DHTML to “draw”. However there is no primitive drawing capability, such as line drawing, provided by the DHTML. Some patent propose the idea of creating tiny blocks to fill the line traced from the mouse movement by the help of DHTML, CSS and Z-positioning (refer to patent X). The idea for that patent is to construct a small square layer filled with pen color, and one can write a script code to insert these small squares to the web page (as an image object) with z-position higher than the components of the web page. The consecutive tiny squares form a zigzagged line overlapped with the web page. Since the script routine is interpreter-based, the response from the routine is slow. The user could see the delay between the drawing and display, and the delay is getting worse when the drawing is accumulated. Furthermore, the slow response also cause that the script routine detect less points from mouse movement so that the squares are actually very sparse (if one square is for one point detected). Another problem with this is that it is hard to improve the zigzagged look of the consecutive square by implementing filtering functions such as anti-aliasing etc.

Third, some web page doesn't follow the DHTML standard and thus the insertion of script routine is impossible.

Because of these problems, the record subsystem uses a transparent window to cover the web page during record. Note that the browser window becomes inactive and the mouse or pen input messages are directed to the top, transparent window.

Now go back to the record mode and subsystem. Each record will start with a pre-record session and then record-session. First, if the user starts the record by pressing the record button (i.e. from idle mode), then the record subsystem will do the following tasks in pre-record session.

Create a new node to represent the new AG item, if the web page or white board that is going to be annotated is not the selected node of the tree.

Change the GUI to record subsystem

Append temp AGS-T2 to temp AGS-T1 (Note for the case of late compression, AGS-T2 actually means the raw audio files, and a temp stream that contains audio flags and other frames. Similar to the AGS-T1) and merge temp EA-T2 to temp EA-T1, if the set of (AGS-T2, EA-T2) is non-empty, reset (AGS-T2, EA-T2) to empty.

Check the record time, if the user intend to insert instead of append (i.e., the user changes the expected record time that is at end of AGS-T1), and if (AGS-T1, EA-T1) is not empty, insert temp AGS-T1 to AGS-O (Note that the system might compress the audio frames before insertion, if it is not done in real-time) and EA-O.

Create scrolling event messages to EA-T2 for the current scrolling status of each frame inside the web page or white board.

Create a transparent window with the size of the browser window to cover the web page, if the annotated target is a web page.

If it is a white board, display stroke frames, image and text blocks that exist before the record time on the white board. If it is a web page, display stroke frames, image and text blocks on the transparent window that exist before the record time and their boundaries have intersection with the current displaying part of the web page.

Enter record session.

Second, if the user switches to record mode during playback, there are two cases. The first case is to insert new stream to the existing stream. The other is to create a new response item to the playback item. For the first case the pre-record tasks are

Change GUI to record subsystem

Copy (AGS-O-C, EA-O-C) to (AGS-O, EA-O) if necessary (recall that the system use temp AGS-O-C and EA-O-C for playback). And clear (AGS-T1, EA-T1) and (AGS-T2, EA-T2).

Note that there is no need for displaying previous graph and create a new transparent window, since they are there already.

For the case of creating a new response item, the pre-record tasks are

Create a new response AG item. Some information members of data structure of the new response AG item inherit the attributes of the original AG item. As an example, the annotated target should be the same, and if it is a web page, the URL of the web page of the original AG item should be the URL of the response AG item etc.

Create a node for the response AG item to the tree as a child of the original AG item.

Save the current displaying part of graph of the original AG item to the new AGS-T2 of the response AG item.

Change GUI to record subsystem

Create scrolling event messages to EA-T2 for the current scrolling status of each frame inside the web page or white board.

Enter record session

Note that in both cases the graph content of the display screen doesn't change from playback mode to record mode. In the later case, part of graphs of original AG item has been saved to the new response AG item. The part of graph is the stroke frames, image and text blocks of original AG item that are currently visible on the computer screen. When the user playback the response AG item, this part of graph will show up instantly at the beginning (time zero).

Whenever the record subsystem enters the record session, the user is able to do the following tasks.

Draw on either the white board or on the transparent window that covers the web page. (This will generate stroke frames to AGS, as well as to temp pure stroke file)

Choose different pen type (solid pen, marker—full transparent, alpha-transparent, horizontal-pen, vertical-pen etc), pen color (RGB), and pen size (thickness—or the maximum thickness of the pen size if the pen is able detect pressure, i.e., thickness could vary from one to the maximum pen size depending on the pressure of each point of the stroke).

Turn on and off the audio (microphone) input to record. (When audio is on, it will generate audio frames)

Pop up or push down the sketch board to draw. (This will generate event message, and the drawing will generate stroke frames, the flag for the stroke is different from the one used for the drawing on the white board or on the web page)

Choose an image file to insert to any position on the window. The image could be moved around and resized. (This will generate event message as well as image frame)

Open a text editor dialog to enter text. The user could choose different font and font size. After closing the editor, the user is able to move the text block (the size is determined by the system) to any position as the image block. Note that when the user insert image or text blocks, the audio input will be automatically off. The user has to turn on the audio later if he wants to. (This will generate event messages and text frame)

Scroll the web page (only the main body) dynamically, or expand the size of the white board by press “expand” control button on tool bar or by press page-down key, for example. (This will generate event messages)

Print screen of displayed window

E-mail

. . .

The user is free to add more functions for the implementation. As pointed out before, the recording generates data frames and event messages. The data frames are audio, stroke, text and image frame that are time synchronously mixed together. The events are save in to EA and later to the header stream.

There is a status bar to show the status of record; such as the current record time of if the audio in is on or off etc.

After the user stop record, the transparent window is removed and the system returns to idle mode.

Playback Mode and Subsystem

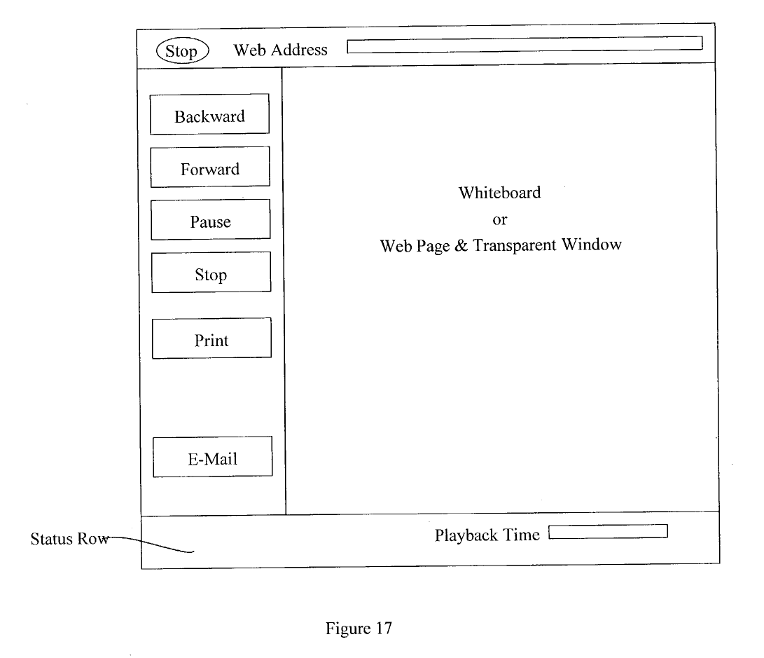

Similarly there are two ways that the system enters the playback mode. First, the user could press the play button on the menu or tool bar to start the playback of the selected AG item or course, which is either local or remote. Or the user could click the ActiveX or Plug-in objects that resides on a web page that invokes the playback subsystem. The playback subsystem starts to download the streams of the target AG item or course on the web site, and at the same time the subsystem starts to play back the downloaded, segmented streams, AGS. The user interface of playback subsystem is shown in FIG. 17. There are tool bar (top and left), editing window (white board) or browser window (web page), and status bar.

For the case of the AG course the playback normally starts with the root AG item and then the child AG items orderly, unless that the user asks the system to start with any particular item.

There are also two sessions for each playback: the pre-playback session and playback session.

The pre-playback session is little different between the cases of local and remote AG items. Assume that the AG item or course is local (says, a received e-mail), i.e., the streams have been in local drive or have been downloaded. And assume the AG item or course has been loaded to the tree. The tasks in the pre-playback session are

Resize the browser window or white board according to the target screen size attribute.

Change GUI to playback subsystem.

Retrieve stroke frames, image and text frames to the pure stroke file, image files and text files respectively, if not been done yet. (This usually happens when the AG item or course is local. If the AG item or course is remote, The retrieving of stroke frames and other are done for each of SDS that has been received).

Download the web page if the annotated target is a web page.

Scroll each frames in the web page or in the white board to the positions determined by the scroll messages in the event array, EA, and the current playtime.

Create transparent window that covers the display window, if the annotated target is a web page.

Display the stroke frames, image and text frames up to the current playtime either on the white board or transparent window (the strokes are retrieved from the pure stroke file and are compared their occurring time with the current playtime, similar to the image and text block; however their occurring times could be retrieved from the EA). Not necessary all the strokes, images and text need to be displayed; the system should check their boundary rectangle with the current display offset to determine that.

Check if the system needs to pop up sketch board or not, if yes, create sketch board and display the stroke frames for sketch board up to the current playtime and after last erasing.

Scan through the data stream up to the current playtime (without displaying the encountered stroke frames, image and text frames).

Start to decode and playback audio frame, stroke frame etc.—i.e., enter the playback session

If the AG item is remote, the tasks in the pre-playback session are

Download the header stream of the AG item, or root AG item if it is a course, and create a node on the tree to load the item, if it has not been downloaded yet.

Resize the browser window or white board according to the target screen size attribute.

Change GUI to the playback subsystem.

Download the web page if the annotated target is a web page.

Download the SDSs of the AG item or course and retrieve stroke frames, image and text frame to the pure stroke file, image files and text files respectively. These tasks are done in the background. (If it is a course, normally the download will start with the SDSs of root AG item, and then the SDSs of companion child AG item in sequence. However if the user chooses to start from any particular child AG item by selecting it on the tree, the download of the system will start with the SDSs of that item, and then the ones follow)

While the system might download SDSs in background, at the same time the system would check if the required SDSs have been received or not (Note that each SDS has a time duration, the system needs to download first several SDSs of the starting item so that the sum of the duration of the SDSs are greater than the play time)

After the required SDSs have been received, follow the step five of the above procedures for the case of local AG item.

There is some additional comment about the playback of an AG course. If the AG course is local, the user could choose any item, the root or any child item to start, by selecting it on the tree. In this case the playback of the course start with the selected AG item, and then the next that follows.

It is similar when the AG course is a remote. When the header stream of the root AG item has been downloaded, then the system knows all the title and locations of the companion child AG items. At this point the user is able to stop the playback, and switch to play any other child AG item. Then the system will pause the current downloading of other AG item and switch to download the selected AG item, if it has not been done yet. Thus the order of items of an AG course that are to be downloaded can be adapted to the user action to improve the performance.

During the playback session the system fetch frames one by one. Each frame is decoded and played or displayed. The audio frame also serves as a timer to display other frames. As an example the stroke, image or text frames that located between audio frame N and N+1 are decoded and displayed at the time of N*D, where D is the time duration of an audio frame. Beside of decoding and playing, the system also monitors the time (audio count) with the EA to see if an event is encountered. Some events such as insertion of image exist both in EA and in data stream so that the system could use this to verify the timing. If an event occurs in EA, the system has to re-generate that event. This could mean to scroll the web page, popup the sketch board, insertion of an image and deletion of an image etc.

Besides that the system has to decode, play, display and re-generate events according to the data stream and event messages, the system also needs to respond to the user interaction. The following are the tasks that user can do during playback.

Pause and resume the playback

Pause the playback and post a question (In this case, the system will create a response AG item to the currently played AG item, part of graph of currently played AG item will become initial graph of the response AG item).

Switch to record (only when the AG item is local and is editable, the system then enter record mode)

Pause and define a time mark

Print

E-mail

. . .

The user can add more functions to the playback subsystem.

The present invention records the data of voices, graphs, texts, or images into “AG Items” (Audio-Graph Items) by “AG Stream” (Audio-Graph Stream). These AG items can be edited for these voices, graphs, texts, and images elements, and also can be sent to related people by e-mail, be uploaded to web sites for downloading or playing, or be recorded into a CD-ROM. If we have any question about the playing contents during the data streams are playing, we may ask for this question immediately and generate an AG item to be a sub one simultaneously, and to reply it to the teachers. The teachers can also answer this question effectively.

For example by long distance learning, the teacher can record the lecturing voices, introduction texts, and graphs descriptions into an AG course (which is integrated by AG items) and send to the students, just likes the course lecturing via blackboards in traditional condition. The students can open any AG item of the AG course (just likes any chapter or section) to play. If the student have any question about some figures, terms, or descriptions during the AG item is playing, he can interrupt (or record) another AG item (replying item) into the playing background at any time and reply to the teacher, just likes to figure out the term “Patent” by a pen and ask, “What does this term mean?” for comment. When receiving the question AG item, the teacher can answer it by generating another replying item and reply to the student, just likes to point out the term “Patent” by the pen and describe, “Paten means concession.” for answer. And then when the student opens the teacher's reply item, he would find that a pen points out the term “Patent” on the monitor and hear the teacher says, “Patent means concession.” So the student can get the answer immediately, and this invention is much more effective than traditional video learning or simple web page slides presentation.

The technique of present invention can also be applied to many different fields, not only for long distance learning. Whenever we need to integrate the voices, graphs, and texts together for long distance communication, the present invention would enhance the efficiency of the communication very well, just likes the proposal discussion between the researching and designing members at two different cities can also progress by this technique. Or somebody has any question about some new terms or pictures on the web pages during web browsing, he may record an AG item for “the actions and voices of figuring out the pictures or texts on the homepage” and send to a professor; after opening the AG item, the professor can record a replying item for answering the question and reply back immediately.

The present invention is a computer method and apparatus to digitize and simulate the classroom lecturing. A teacher can use the apparatus to draw on a web page or on a computer whiteboard with extensible size, dynamically insert (delete) image and text objects into (from) the whiteboard or the web page, and record voice narration at the same time. The apparatus stores these activities into a multiplexed data stream and a header stream. The combination of streams and the annotated web page is called an audio-graph (AG) item. Users could save the streams to a file, e-mail it, or upload it to a web site for streamed playback. The apparatus is a system of authoring, playback, organize, and indexing the AG items. The data stream of an AG item comprises compressed audio frames, compressed stroke frames, image and text frames. The header stream comprises information messages, and event messages (with timing) that are used to control the display (window) during playback. By using event messages and stroke temp files (a text file of strokes), the present invention is able to reduce the delay caused by the pre-processing before user can begin to input voice and stroke during record, or before user can begin to see result during playback. The present invention uses multiple event arrays internally to reduce the frequency and complexity of data stream (file) manipulation during editing (e.g., insert new data stream by record). The system segments the usually very long data stream to many smaller segmented data streams before the AG item is uploaded to the web site. The segmentation information (such as the number of the segments) and the locations are stored in the header stream. The separation of streams to header and segmented data streams enable online playback with little waiting time, even for a very slow and congested network. A group of AG items could be constructed to an AG course. An AG course could be a linked or embedded. A linked AG course is that some of its AG items are stored outside of the AG course file; otherwise it is an embedded AG course. User can save a course to a file, e-mail it or publish to the web site just like a single AG item.

To sum up, recording the activities of lecturing, graphs drawing, and words typing (writing) of present invention and related applications is a brand new technique, which can enhance the efficiency of long distance learning. Because the present invention is a brand new contrivance with practicability, so we apply for the patent right by the rules. Due to the invocations of present invention are not enough to cover entire present patent, so the scope of patent right is listed as the attachment.

What is claimed is:

1. A method for computer digitized lecturing, said method progressing in a computer and comprising steps of:
generating a data stream, said data stream contains a multiplexed data stream and a header stream to carry a multimedia data;
editing said data stream, to insert a first multimedia data into said data stream, and delete a secondary multimedia data from said data stream; and
transferring said data stream in order to upload and download said data stream.

2. A method according to claim 1 wherein said computer is linked to a web site, and said computer is able to save said data stream, e-mail said data stream, and upload said data stream to said web site for playback.

3. A method according to claim 1 wherein said data stream and an annotated web page is combined into an audio-graph (AG) item, and said header stream contains an information message and an event message.

4. A method according to claim 1 wherein a user should be able to authorize, playback, organize, and index said audio-graph item.

5. A method according to claim 1 wherein said multimedia data is compressed data of a course content, said course content is progressed on a computer whiteboard by a lecturer, said lecturer should be able to summarize said course content into a course item.

6. A method according to claim 5 wherein said multimedia data is a reply content, said reply content is made by a student for applying questions about said course content, said reply content can be summarized into a reply item.

7. A method for computer digitized lecturing, said method comprising steps of:
providing a computer whiteboard, a voice input device, and a graphic input device;
recording a first voice by said voice input device, recording a first graph on said computer whiteboard by said graphic input device, and forming a first stream;
transferring said first stream; and
playbacking said first stream, and at the same time recording a second voice by said voice input device, recording a second graph on said computer whiteboard by said graphic input device a, and forming a second stream.

8. A method according to claim 7 wherein said voice input device is a microphone, and said graphic input device is an input pen.

9. A method according to claim 7 wherein said computer whiteboard can be replaced by a web page, and said graphic input device will draw said graph on a transparent window over said web page during recording.

10. A method according to claim 7 wherein said computer whiteboard is an empty web page.

11. A method according to claim 7 wherein a data of said stream is compressed, said stream contains a multiplexed stream and a header stream, and said header stream contains an information message and an event message.
